(19) United States
(12) Patent Application Publication
(10) Pub. No.: US 2015/0251257 A1
(43) Pub. Date: Sep. 10, 2015

(54) RECIPROCATING CUTTER

(71) Applicant: Mike Shaw, Acworth, GA (US)

(72) Inventor: Mike Shaw, Acworth, GA (US)

(21) Appl. No.: 14/198,541

(22) Filed: Mar. 5, 2014

(51) Int. Cl. B23D 57/00

(52) U.S. Cl. CPC B23D 57/0015

(57) ABSTRACT

A reciprocating cutter system for use in spaces where a typical saw is unable to operate due to size, space, and operability limitations is disclosed. In at least one embodiment a reciprocating cutter system includes: a housing; a handle disposed on a top portion of the housing to provide an operator a user grip to operate the system; a cable saw coupled to the housing of reciprocating cutter system; a spring disposed within the housing and coupled to the cable saw such that as the cable saw is moved in a back-and-forth motion when in use, the spring also moves in a back-and forth-motion without the operator-held handle needing to move; and a connectivity bit, coupled to the cable saw, to connect the wire saw through the connectivity bit to a reciprocating device, the reciprocating device to provide the back-and-forth motion to the connectivity bit and the cable saw.

### FIELD OF THE INVENTION

The technology described herein relates generally to the fields of cutting tools, power driven saw cutting equipment, and portable oscillating, coping, and reciprocating power saws. More specifically, this technology relates to a reciprocating cutter for use in spaces where a typical saw is unable to operate due to size, space, and operability limitations. Furthermore, this technology relates to a reciprocating cutter having a spring-loaded handle, cable saw, and connectivity bit for coupling to a reciprocating saw or like device.

### BACKGROUND OF THE INVENTION

Certain cutting tools, power driven saw cutting equipment, and portable oscillating, coping, and reciprocating power saws are known in the background art that enable one to make cuts with a coping, reciprocating, cutting, or like means. Operating such devices in areas that are limited in space provides additional difficulties. Known devices and systems are inefficient to effectively overcome such difficulties. Others have attempted to overcome these deficiencies with hanging devices of various constructions; however, these devices also have been found to have various shortcomings and deficiencies as well.

Related utility patents known in the art include the following:

U.S. Pat. No. 5,077,902, issued to Hitt on Jan. 7, 1992, discloses a power driven vibrating wire saw.

U.S. Pat. No. 5,924,209, issued to Ward on Jul. 20, 1999, discloses a powered coping saw.

U.S. Pat. No. 3,895,438, issued to Burkepile et al. on Jul. 22, 1975, discloses a Styrofoam cutting tool.

U.S. Pat. No. 3,587,679, issued to Conte on Jun. 28, 1971, discloses a portable cable saw.

U.S. Pat. No. 5,220,729, issued to Gallant on Jun. 22, 1993, discloses a hand-held wire saw.

U.S. Pat. No. 3,598,101, issued to Hensley on Aug. 10, 1971, discloses a wire saw.

U.S. Pat. No. 3,270,369, issued to Mandell on Sep. 6, 1966, discloses a reciprocating saw.

U.S. Pat. No. 3,461,732, issued to Gregory on Aug. 19, 1969, discloses a portable power driven reciprocating saw.

U.S. Pat. No. 6,851,194, issued to Chen et al. on Feb. 8, 2005, discloses a reciprocating saw having a blade holding device.

U.S. Pat. No. 7,631,584, issued to Quinn on Dec. 15, 2009, discloses a tool adaptor for use with a reciprocating saw.

U.S. Pat. No. 6,370,780, issued to Robertson et al. on Apr. 16, 2002, discloses a spring-biased cutting tool for plastic pipes.

U.S. Pat. No. Re. 29,803, reissued to Breese on Oct. 7, 1978, discloses a pipe cutting tool.

Related U.S. patent application publications known in the art include the following:

U.S. Patent Application Publication No. 2010/0186564, filed by Pierce and published on Jul. 29, 2010, discloses a wire saw.

Related design patents known in the art include the following:

U.S. Pat. No. Des. 690,176, issued to Ronan on Sep. 24, 2013, discloses the ornamental design for a PVC cutter.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a reciprocating cutter for use in spaces where a typical saw is unable to operate due to size, space, and operability limitations. Additionally, the technology described herein provides a reciprocating cutter having a spring-loaded handle, cable saw, and connectivity bit for coupling to a reciprocating saw or like device.

In one exemplary embodiment, the technology described herein provides a reciprocating cutter system for use in spaces where a typical saw is unable to operate due to size, space, and operability limitations. The reciprocating cutter system includes: a housing; a handle securely disposed on a top portion of the housing to provide an operator a user grip to operate the system; a cable saw coupled to the housing of reciprocating cutter system; a spring securely disposed within the housing and coupled to the cable saw such that as the cable saw is moved in a back-and-forth motion when in use, the spring also moves in a back-and forth-motion without the operator-held handle needing to move; and a connectivity bit, coupled to the cable saw, to connect the wire saw through the connectivity bit to a reciprocating device, the reciprocating device to provide the back-and-forth motion to the connectivity bit and therefore the cable saw.

In at least one embodiment, the reciprocating cutter system also includes: a first pin with which to couple the cable saw to the housing of reciprocating cutter system; and a second pin with which to couple the cable saw to the connectivity bit to connect the wire saw to the reciprocating device. The cable saw is thus interchangeable and replaceable.

In at least one embodiment, the reciprocating cutter system further includes an end cap securely disposed about a circumference of the housing at a distal end of the housing from the handle to provide a backstop to the spring securely disposed within the housing, the end cap further defined by an aperture in the center of the end cap and the aperture of a diameter just larger than the cable saw such that the cable saw feeds through the aperture to couple to the spring securely disposed within the housing.

In at least one embodiment, the reciprocating cutter system also includes a cable guide securely disposed to the end cap at the distal end of the housing to provide a guide to the cable saw as the cable saw moves in the back-and-forth motion within the end cap of the housing and to prevent wear by the cable saw to the end cap.

In at least one embodiment, the reciprocating cutter system further includes an anchor disposed within the housing and also within a center channel of the spring and coupled to the cable saw, thereby configured to fasten securely the cable saw to the spring.

In at least one embodiment of the reciprocating cutter system, the handle comprises a rigid handle having two wings with which to grip the reciprocating cutter system.

In at least one embodiment of the reciprocating cutter system, the handle comprises a wire loop handle with which to grip the reciprocating cutter system.

In at least one embodiment, the reciprocating cutter system also includes a protective sheath to cover the wire loop handle and protect the hand of the operator from wear.

In at least one embodiment, the reciprocating cutter system further includes an aperture disposed within the connectivity bit for coupling to the reciprocating device to lock in place the connectivity bit to the reciprocating device.

In at least one embodiment of the reciprocating cutter system, the connectivity bit coupled to the cable saw is generally cylindrical on a first end to receive the cable saw and substantially flat on a second end for placement within a receiving area the reciprocating device.

In another exemplary embodiment, the technology described herein provides a disposable reciprocating cutter system for use in spaces where a typical saw is unable to operate due to size, space, and operability limitations. In this embodiment, the reciprocating cutter system includes: a housing; a wire loop handle securely disposed on a top portion of the housing to provide an operator a user grip to operate the system; a cable saw coupled to the housing of reciprocating cutter system; a spring securely disposed within the housing and coupled to the cable saw such that as the cable saw is moved in a back-and-forth motion when in use, the spring also moves in a back-and forth-motion without the operator-held handle needing to move; a cable guide securely disposed to the end cap at the distal end of the housing to provide a guide to the cable saw as the cable saw moves in the back-and-forth motion within the end cap of the housing and to prevent wear by the cable saw to the end cap; and a connectivity bit integrally formed with the cable saw, to connect the wire saw through the connectivity bit to a reciprocating device, the reciprocating device to provide the back-and-forth motion to the connectivity bit and therefore the cable saw. The cable saw in this embodiment is utilized without coupling pins and is disposable.

In at least one embodiment, the disposable reciprocating cutter system also includes an end cap securely disposed about a circumference of the housing at a distal end of the housing from the handle to provide a backstop to the spring securely disposed within the housing, the end cap further defined by an aperture in the center of the end cap and the aperture of a diameter just larger than the cable saw such that the cable saw feeds through the aperture to couple to the spring securely disposed within the housing.

In at least one embodiment, the disposable reciprocating cutter system further includes an anchor disposed within the housing and also within a center channel of the spring and coupled to the cable saw, thereby configured to fasten securely the cable saw to the spring.

In at least one embodiment, the disposable reciprocating cutter system also includes a protective sheath to cover the wire loop handle and protect the hand of the operator from wear.

In at least one embodiment, the disposable reciprocating cutter system further includes an aperture disposed within the connectivity bit for coupling to the reciprocating device to lock in place the connectivity bit to the reciprocating device.

In at least one embodiment of the disposable reciprocating cutter system, the connectivity bit coupled to the cable saw is generally cylindrical on a first end to receive the cable saw and substantially flat on a second end for placement within a receiving area the reciprocating device.

In another exemplary embodiment, the technology described herein provides a reciprocating cutter system for use in spaces where a typical saw is unable to operate due to size, space, and operability limitations. The reciprocating cutter system includes: a power-driven reciprocating tool to provide a back-and-forth motion; a housing; a handle disposed on a top portion of the housing to provide an operator a user grip to operate the system; a cable saw coupled to the housing of reciprocating cutter system; a spring securely disposed within the housing and coupled to the cable saw such that as the cable saw is moved in the back-and-forth motion when in use coupled to the power-driven reciprocating tool, the spring also moves in a back-and forth-motion without the operator-held handle needing to move; and a connectivity bit, coupled to the cable saw, to connect the wire saw through the connectivity bit to the power-driven reciprocating tool, the power-driven reciprocating tool to provide the back-and-forth motion to the connectivity bit and therefore the cable saw.

In at least one embodiment, the reciprocating cutter system also includes: a first pin with which to couple the cable saw to the housing of reciprocating cutter system; and a second pin with which to couple the cable saw to the connectivity bit to connect the wire saw to the reciprocating device. The cable saw is thus interchangeable and replaceable.

In at least one embodiment, the reciprocating cutter system further includes: an end cap securely disposed about a circumference of the housing at a distal end of the housing from the handle to provide a backstop to the spring securely disposed within the housing, the end cap further defined by an aperture in the center of the end cap and the aperture of a diameter just larger than the cable saw such that the cable saw feeds through the aperture to couple to the spring securely disposed within the housing; an anchor disposed within the housing and also within a center channel of the spring and coupled to the cable saw, thereby configured to fasten securely the cable saw to the spring; and a protective sheath to cover the wire loop handle and protect the hand of the operator from wear.

In at least one embodiment, the reciprocating cutter system further includes an aperture disposed within the connectivity bit for coupling to the reciprocating device to lock in place the connectivity bit to the reciprocating device. The connectivity bit coupled to the cable saw is generally cylindrical on a first end to receive the cable saw and substantially flat on a second end for placement within a receiving area the reciprocating device.

Advantageously, the technology described herein provides a reciprocating cutter for use in spaces where a typical saw is unable to operate due to size, space, and operability limitations. Known cutting devices are incapable of achieving the functionality of the disclosed device as describe herein.

Also advantageously, the technology described herein provides a reciprocating cutter having a spring-loaded handle, cable saw, and connectivity bit for coupling to a reciprocating saw or like device. Such a configuration is not known in the art and provides solutions to many problem events due to size, space, and operability limitations.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a reciprocating cutter system for use in spaces where a typical saw is unable to operate due to size, space, and operability limitations, illustrating, in particular, a spring-loaded handle, a wire saw, coupling pins, and a connectivity bit for coupling to a reciprocating saw or like device, according to an embodiment of the technology described herein;

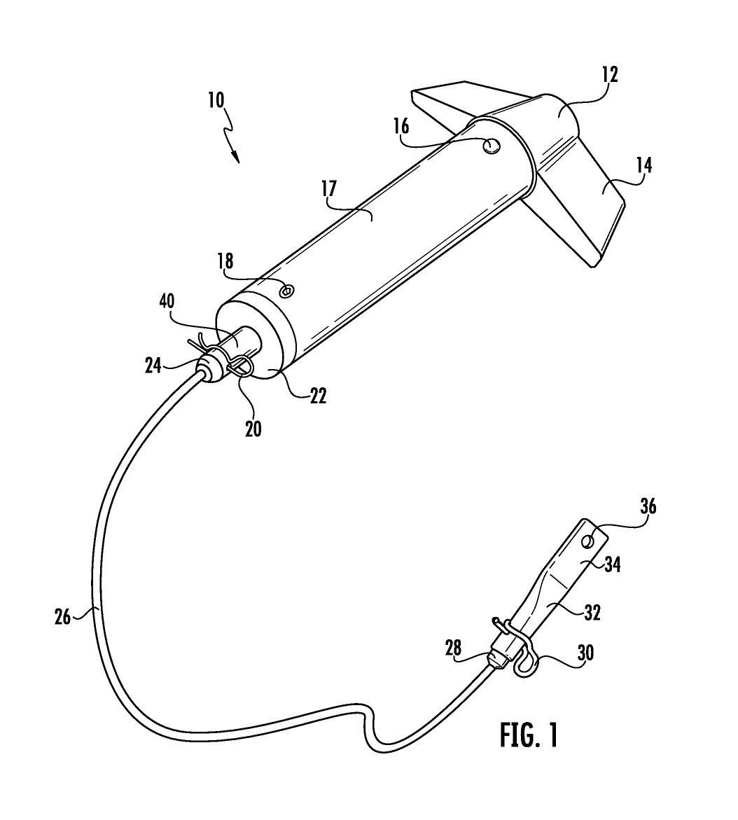

FIG. 2 is a side view of the reciprocating cutter system depicted in FIG. 1, and illustrating, in particular, how the wire saw portion is coupled to the handle portion, according to an embodiment of the technology described herein;

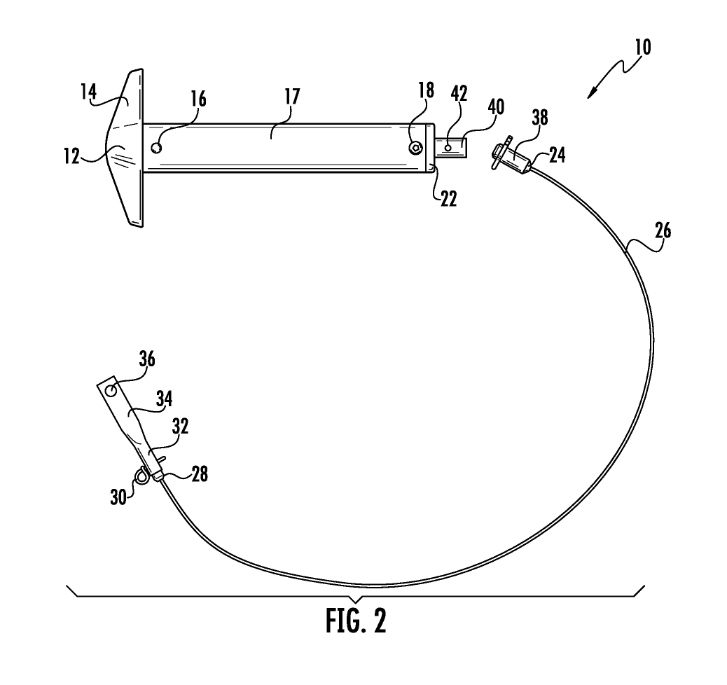

FIG. 3 is a cross section view of the reciprocating cutter system depicted in FIG. 1, and illustrating, in particular, the internal spring portion of the system that counteracts the reciprocating motion of an attached reciprocating saw when the device is in use, according to an embodiment of the technology described herein;

FIG. 4 is a close-up view of the connectivity bit for coupling to a reciprocating saw or like device, illustrating, in particular, a coupling pin to couple the wire saw to the connectivity bit, and the flat saw-blade-like shape of the connectivity bit for use in a reciprocating saw when the device is in use, according to an embodiment of the technology described herein;

FIG. 5 is a perspective view of the reciprocating cutter system depicted in FIG. 1, and illustrating, in particular, the device in use with a reciprocating saw and cutting a piece of pipe, for example, with the wire saw portion, according to an embodiment of the technology described herein; and

FIG. 6 is a front perspective view of a reciprocating cutter system similar to that depicted in FIG. 1, but illustrating, in particular, a more permanent, disposable version having no connectivity pins and having a loop handle, according to an embodiment of the technology described herein;

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a reciprocating cutter for use in spaces where a typical saw is unable to operate due to size, space, and operability limitations. Additionally, the technology described herein provides a reciprocating cutter having a spring-loaded handle, cable saw, and connectivity bit for coupling to a reciprocating saw or like device. Furthermore, various embodiments include a cable saw cutter system that is used many times and in which the cable portion is interchangeable and replaceable, a disposable cable saw cutter system, and a complete cable saw system that also includes a reciprocating device.

Referring now to the figures, a reciprocating cutter system 10 is shown. The reciprocating cutter system 10 is configured for use in spaces where a typical saw is unable to operate due to size, space, and operability limitations.

The reciprocating cutter system 10 includes a housing 17. In at least one embodiment, the housing 17 is metal. In at least one embodiment, the housing 17 is plastic and transparent such that one can observe the internal workings, such as the spring 43 extending and retracting in action. The housing 17 is comprised of a sturdy, rigid material for use with power tools such as a reciprocating device 50, for example. The housing 17 provides an enclosure for system elements defined below, and is designed to regular use with the reciprocating device 50.

The reciprocating cutter system 10 includes a handle 12 securely disposed on a top portion of the housing 17 to provide an operator a user grip to operate the system. The handle 12 includes in at least one embodiment a pair of handle flanges 14 or wings with which a user can grip the handle 12. The handle 12 is metal and solid in at least one embodiment. The handle 12 is a sturdy plastic material in at least one alternative embodiment.

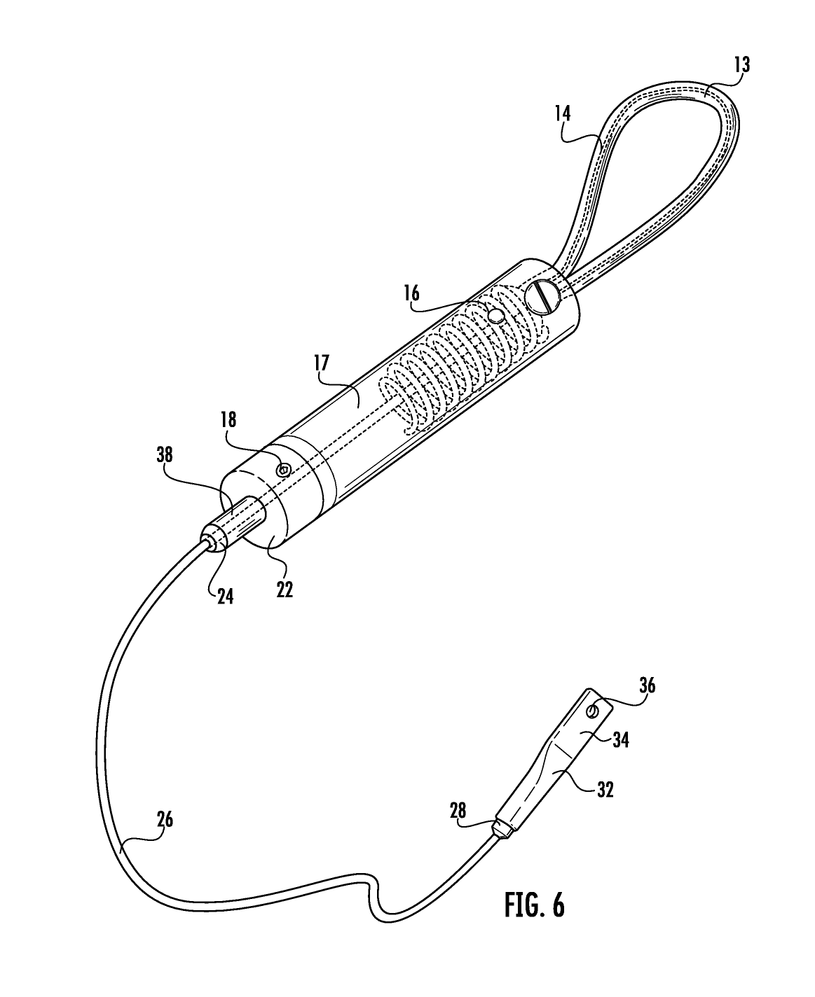

In at least one embodiment, the handle is a loop handle 13, as is depicted specifically in FIG. 6. In this embodiment, the handle 13 can be a wire 14. The loop handle 13 is coupled to the housing 17 and top cap 15, which securely holds the handles to the housing. The embodiment can further include a protective sheath to cover the wire 14 loop handle 13 and protect the hand of the operator from wear. In at least one embodiment, the loop handle 13 includes a wire loop 14, and can be in fact the same wire as used for the cable saw, defined below, but at an opposite end of the spring 43 disposed within the housing 17.

The reciprocating cutter system 10 includes a cable saw 26 coupled to the housing 17 of reciprocating cutter system 10. The cable 26 is a wire saw in at least one embodiment. The cable saw 26 is the key cutting component of the devices and systems disclosed herein. As the cable saw 26 is moved rapidly in a back-and-forth manner, such as when coupled to reciprocating device 50, the cable saw provides a cutting action on an item.

By way of example, in plumbing, one can use the reciprocating cutter system 10 to cut a PVC pipe, for example. The reciprocating cutter system 10 provides a means to rapidly cut such a PVC pipe, and enable the operator to do so in places where a traditional reciprocating saw, or the like, would not have adequate space in which to operate safely and properly.

In various embodiments, the cable saw 26 is a more permanent solution with the wire itself being replaceable and interchangeable as needed. In alternative embodiments, and as will be discussed below, the cable saw 26 is disposable after a certain number of uses or hours. In various embodiments, the cable saw 26 can vary in gages of wire used. Additionally, in various embodiments, the cable saw 26 can include additional cutting aids, such as bits, for example.

In various embodiments, the cable saw 26 includes fasteners. By way of example, first fastener 24 is coupled to cable saw 26 and provides a means by which the cable saw 26 base end 38 is coupled within the cable guide 40 and secured with first pin 20. Also, by way of example, the second fastener 28 is coupled to the cable saw 26 and provides a means by which the cable saw 26 is coupled to the connectivity bit 32 and secured with second pin 30.

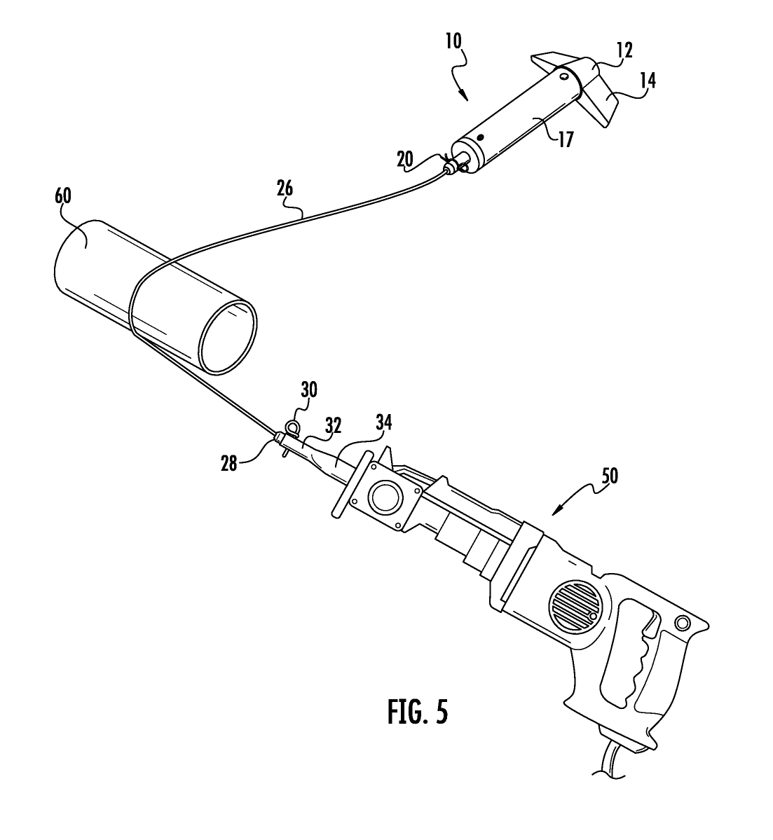

The reciprocating cutter system 10 includes a spring 43 securely disposed within the housing 17 and coupled to the cable saw 26. As the cable saw 26 is moved in a back-and-forth motion when in use, such as by reciprocating device 50 depicted in FIG. 5, the spring 43 also moves in a back-and forth-motion without the operator-held handle 12 needing to move. The spring-loaded handle 12 thus provides the operator a means by which to “hold” the end of the cable saw opposite the reciprocating device 50, and the spring 43 contained within is a shock absorber and enabler for the back-and-forth reciprocating motion. Spring stop washer 41 disposed between spring 43 and cable guide 40 prevents the spring 43 from being overextended.

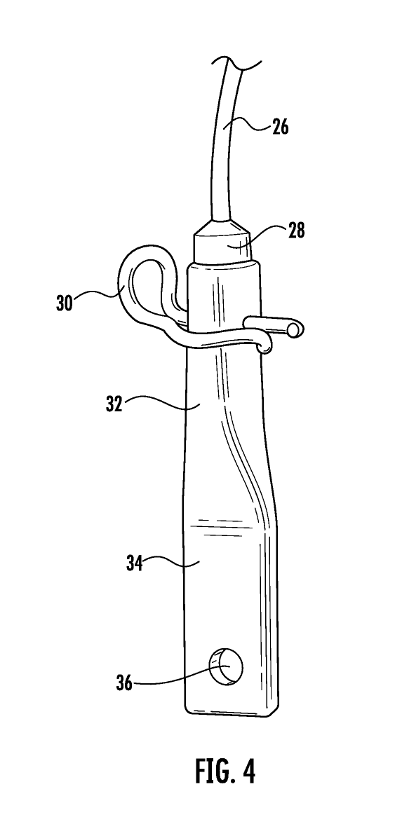

The reciprocating cutter system 10 includes a connectivity bit 32. The connectivity bit 32 is depicted in close-up view in FIG. 4. The connectivity bit 32 is coupled to the cable saw 26 and connect the cable saw 26 through the connectivity bit 32 to a reciprocating device 50. The reciprocating device 50 provides the back-and-forth motion to the connectivity bit 32 and therefore the cable saw 26. In at least one embodiment, the cable saw 26 and the connectivity bit 32 are integrally formed and used as a single item.

In at least one embodiment, the connectivity bit 32 further includes an aperture 36. The aperture 36 enables the connectivity bit 32 to be coupled to the reciprocating device 50 to lock in place the connectivity bit 32 to the reciprocating device 50. The aperture 36 is designed to enable an operator to quickly and easily interchange the connectivity bit 32 with the reciprocating device 50.

In at least one embodiment, the connectivity bit 32, which coupled to the cable saw 26, is generally cylindrical on a first end (near 32) to receive the cable saw 26 and substantially flat on a second end 34 for placement within a receiving area the reciprocating device 50. Between the cylindrical area (near 32) and the substantially flat end 34 is a gentle taper going from the cylindrical shape to the flat element.

In at least one embodiment, the reciprocating cutter system 10 includes a first pin 20 with which to couple the cable saw 26 to the housing 17 of reciprocating cutter system 10. The reciprocating cutter system 10 also includes a second pin 30 with which to couple the cable saw 26 to the connectivity bit 32 to connect the cable saw 26 to the reciprocating device 50. The cable saw 26 is thus interchangeable and replaceable in this embodiment. In alternative embodiments, the cable saw 26 is integrally formed with the connectivity bit 32. In alternative embodiments, the cable saw 26 is integrally formed with the housing 17.

The reciprocating cutter system 10 includes an end cap 22 securely disposed about a circumference of the housing 17 at a distal end of the housing 17 from the handle 12. The end cap 22 provides a backstop to the spring 43 securely disposed within the housing 17. The end cap 22 further defined by an aperture in the center of the end cap 22. The aperture is of a diameter just larger than that of the cable saw 26 such that the cable saw 26 feeds through the aperture to couple to the spring 43 securely disposed within the housing 17.

The reciprocating cutter system 10 includes a cable guide 40. The cable guide 40 is securely disposed to the end cap 22 at the distal end of the housing 17. The cable guide 40 provides a guide to the cable saw 26 as the cable saw 26 moves in the back-and-forth motion, as reciprocated by the reciprocating device 50 for example, within the end cap 22 of the housing 17. The cable guide 40 therefore helps to prevent wear by the cable saw 26 to the end cap 22.

The reciprocating cutter system 10 includes an anchor 42 disposed within the housing 17. The anchor 42 is further disposed within a center channel of the spring 43 and thereby coupled to the cable saw 26. The anchor 42 is configured to fasten securely the cable saw 26 to the spring 43. The anchor 42 is comprised of a sturdy metal in at least one embodiment.

As depicted in FIG. 6, the reciprocating cutter system 10 in at least one embodiment is a disposable version. The disposable version of the reciprocating cutter system 10 is configured for use in spaces where a typical saw is unable to operate due to size, space, and operability limitations and once used a certain numbers of times or a certain number of hours is disposable.

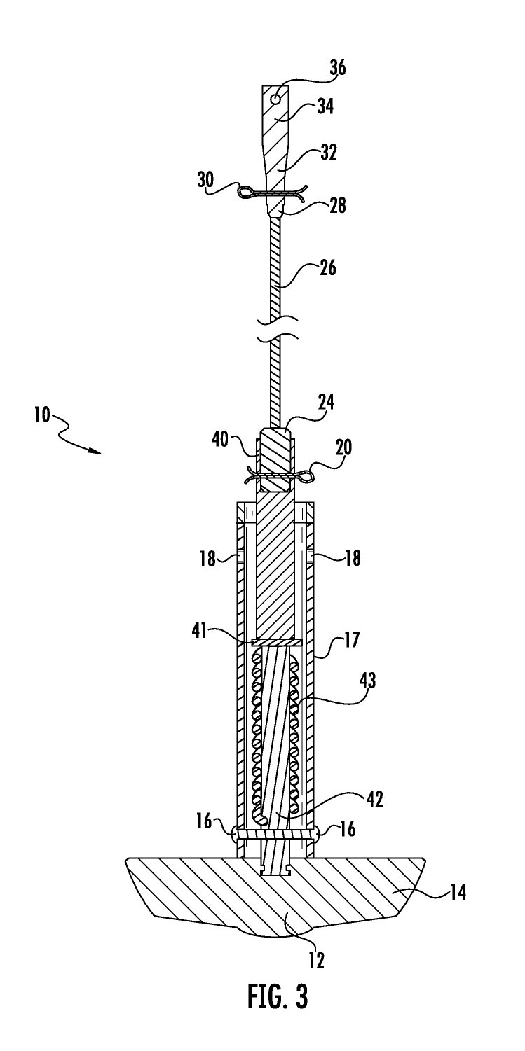

The disposable reciprocating cutter system includes: a housing 17; a loop handle 13 securely disposed on a top portion of the housing to provide an operator a user grip to operate the system; a cable saw 26 coupled to the housing of reciprocating cutter system; a spring 43 (within the housing 17, but as shown in FIG. 3) securely disposed within the housing 17 and coupled to the cable saw 26 such that as the cable saw 26 is moved in a back-and-forth motion when in use, the spring 43 also moves in a back-and forth-motion without the operator-held handle needing to move; and a cable guide 40 securely disposed to the end cap 22 at the distal end of the housing 17 to provide a guide to the cable saw 26 as the cable saw 26 moves in the back-and-forth motion within the end cap 22 of the housing 17 and to prevent wear by the cable saw 26 to the end cap 22; and a connectivity bit 32 integrally formed with the cable saw 26, to connect the cable saw 26 through the connectivity bit 26 to a reciprocating device 50, the reciprocating device 50 to provide the back-and-forth motion to the connectivity bit and therefore the cable saw 26. In this disposable embodiment, the cable saw 26 is utilized without coupling pins and is disposable. Rivets 16, 18 or the like are utilized instead of pins.

In this embodiment, the disposable reciprocating cutter system includes a top cap 15. The top cap 15 secure the loop handle 13 to the housing 13. Additionally elements that can be included in the disposable version have been defined previously in regard to the non-disposable version.

In another exemplary embodiment, a complete reciprocating cutter system for use in spaces where a typical saw is unable to operate due to size, space, and operability limitations also includes a reciprocating device.

In this complete system embodiment, the reciprocating cutter system 10 includes: a power-driven reciprocating tool 50 to provide a back-and-forth motion; a housing 17; a handle 12 disposed on a top portion of the housing 12 to provide an operator a user grip to operate the system; a cable saw 26 coupled to the housing 17 of reciprocating cutter system; a spring 43 securely disposed within the housing 17 and coupled to the cable saw 26 such that as the cable saw 26 is moved in the back-and-forth motion when in use coupled to the power-driven reciprocating tool, the spring 43 also moves in a back-and forth-motion without the operator-held handle needing to move; and a connectivity bit 32, coupled to the cable saw 26, to connect the cable saw 26 through the connectivity bit 32 to the power-driven reciprocating tool 50, the power-driven reciprocating tool 50 to provide the back-and-forth motion to the connectivity bit and therefore the cable saw.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A reciprocating cutter system for use in spaces where a typical saw is unable to operate due to size, space, and operability limitations, the reciprocating cutter system comprising:
a housing;
a handle securely disposed on a top portion of the housing to provide an operator a user grip to operate the system;
a cable saw coupled to the housing of reciprocating cutter system;
a spring securely disposed within the housing and coupled to the cable saw such that as the cable saw is moved in a back-and-forth motion when in use, the spring also moves in a back-and forth-motion without the operator-held handle needing to move; and
a connectivity bit, coupled to the cable saw, to connect the wire saw through the connectivity bit to a reciprocating device, the reciprocating device to provide the back-and-forth motion to the connectivity bit and therefore the cable saw.

2. The reciprocating cutter system of claim 1, further comprising:
a first pin with which to couple the cable saw to the housing of reciprocating cutter system;
a second pin with which to couple the cable saw to the connectivity bit to connect the wire saw to the reciprocating device;
wherein the cable saw is thus interchangeable and replaceable.

3. The reciprocating cutter system of claim 1, further comprising:
an end cap securely disposed about a circumference of the housing at a distal end of the housing from the handle to provide a backstop to the spring securely disposed within the housing, the end cap further defined by an aperture in the center of the end cap and the aperture of a diameter just larger than the cable saw such that the cable saw feeds through the aperture to couple to the spring securely disposed within the housing.

4. The reciprocating cutter system of claim 3, further comprising:
a cable guide securely disposed to the end cap at the distal end of the housing to provide a guide to the cable saw as the cable saw moves in the back-and-forth motion within the end cap of the housing and to prevent wear by the cable saw to the end cap.

5. The reciprocating cutter system of claim 1, further comprising:
an anchor disposed within the housing and also within a center channel of the spring and coupled to the cable saw, thereby configured to fasten securely the cable saw to the spring.

6. The reciprocating cutter system of claim 1, wherein the handle comprises a rigid handle having two wings with which to grip the reciprocating cutter system.

7. The reciprocating cutter system of claim 1, wherein the handle comprises a loop handle with which to grip the reciprocating cutter system.

8. The reciprocating cutter system of claim 7, further comprising:
a protective sheath to cover the loop handle and protect the hand of the operator from wear.

9. The reciprocating cutter system of claim 1, further comprising:
an aperture disposed within the connectivity bit for coupling to the reciprocating device to lock in place the connectivity bit to the reciprocating device.

10. The reciprocating cutter system of claim 1, wherein the connectivity bit coupled to the cable saw is generally cylindrical on a first end to receive the cable saw and substantially flat on a second end for placement within a receiving area the reciprocating device.

11. A disposable reciprocating cutter system for use in spaces where a typical saw is unable to operate due to size, space, and operability limitations, the reciprocating cutter system comprising:
a housing;
a loop handle securely disposed on a top portion of the housing to provide an operator a user grip to operate the system;
a cable saw coupled to the housing of reciprocating cutter system;
a spring securely disposed within the housing and coupled to the cable saw such that as the cable saw is moved in a back-and-forth motion when in use, the spring also moves in a back-and forth-motion without the operator-held handle needing to move; and
an end cap securely disposed about a circumference of the housing at a distal end of the housing from the handle to provide a backstop to the spring securely disposed within the housing, the end cap further defined by an aperture in the center of the end cap and the aperture of a diameter just larger than the cable saw such that the cable saw feeds through the aperture to couple to the spring securely disposed within the housing;
a cable guide securely disposed to the end cap at the distal end of the housing to provide a guide to the cable saw as the cable saw moves in the back-and-forth motion within the end cap of the housing and to prevent wear by the cable saw to the end cap;
a connectivity bit integrally formed with the cable saw, to connect the wire saw through the connectivity bit to a reciprocating device, the reciprocating device to provide the back-and-forth motion to the connectivity bit and therefore the cable saw;
wherein the cable saw is utilized without coupling pins and is disposable.

12. The disposable reciprocating cutter system of claim 11, further comprising:
an end cap securely disposed about a circumference of the housing at a distal end of the housing from the handle to provide a backstop to the spring securely disposed within the housing, the end cap further defined by an aperture in the center of the end cap and the aperture of a diameter just larger than the cable saw such that the cable saw feeds through the aperture to couple to the spring securely disposed within the housing.

13. The disposable reciprocating cutter system of claim 11, further comprising:
an anchor disposed within the housing and also within a center channel of the spring and coupled to the cable saw, thereby configured to fasten securely the cable saw to the spring.

14. The disposable reciprocating cutter system of claim 11, further comprising:
a protective sheath to cover the wire loop handle and protect the hand of the operator from wear.

15. The disposable reciprocating cutter system of claim 11, further comprising:
an aperture disposed within the connectivity bit for coupling to the reciprocating device to lock in place the connectivity bit to the reciprocating device.

16. The disposable reciprocating cutter system of claim 11, wherein the connectivity bit coupled to the cable saw is generally cylindrical on a first end to receive the cable saw and substantially flat on a second end for placement within a receiving area the reciprocating device.

17. A reciprocating cutter system for use in spaces where a typical saw is unable to operate due to size, space, and operability limitations, the reciprocating cutter system comprising:
a power-driven reciprocating tool to provide a back-and-forth motion;
a housing;
a handle disposed on a top portion of the housing to provide an operator a user grip to operate the system;
a cable saw coupled to the housing of reciprocating cutter system;
a spring securely disposed within the housing and coupled to the cable saw such that as the cable saw is moved in the back-and-forth motion when in use coupled to the power-driven reciprocating tool, the spring also moves in a back-and forth-motion without the operator-held handle needing to move; and
a connectivity bit, coupled to the cable saw, to connect the wire saw through the connectivity bit to the power-driven reciprocating tool, the power-driven reciprocating tool to provide the back-and-forth motion to the connectivity bit and therefore the cable saw.

18. The reciprocating cutter system of claim 17, further comprising:
a first pin with which to couple the cable saw to the housing of reciprocating cutter system;
a second pin with which to couple the cable saw to the connectivity bit to connect the wire saw to the reciprocating device;
wherein the cable saw is thus interchangeable and replaceable.

19. The reciprocating cutter system of claim 17, further comprising:
an end cap securely disposed about a circumference of the housing at a distal end of the housing from the handle to provide a backstop to the spring securely disposed within the housing, the end cap further defined by an aperture in the center of the end cap and the aperture of a diameter just larger than the cable saw such that the cable saw feeds through the aperture to couple to the spring securely disposed within the housing;
an anchor disposed within the housing and also within a center channel of the spring and coupled to the cable saw, thereby configured to fasten securely the cable saw to the spring; and
a protective sheath to cover the wire loop handle and protect the hand of the operator from wear.

20. The reciprocating cutter system of claim 17, further comprising:
an aperture disposed within the connectivity bit for coupling to the reciprocating device to lock in place the connectivity bit to the reciprocating device; and
wherein the connectivity bit coupled to the cable saw is generally cylindrical on a first end to receive the cable saw and substantially flat on a second end for placement within a receiving area the reciprocating device.
